(19) United States
(12) Patent Application Publication
(10) Pub. No.: US 2026/0103557 A1
(43) Pub. Date: Apr. 16, 2026

(54) TRANSPARENT POLYMERIC MATERIALS WITH HIGH OXYGEN DIFFUSION THAT ARE FREE OF THE ELEMENT FLUORINE

(71) Applicant: Acuity Polymers, Inc., Rochester, NY (US)

(72) Inventors: Wayne Ferrar, Fairport, NY (US); Shu-Min Hsu, Rochester, NY (US); James A. Bonafini, JR., Kendall, NY (US)

(21) Appl. No.: 19/419,783

(22) Filed: Dec. 15, 2025

Related U.S. Application Data
(63) Continuation of application No. PCT/US2024/034411, filed on Jun. 17, 2024.
(60) Provisional application No. 63/508,662, filed on Jun. 16, 2023.

(51) Int. Cl. C08F 290/06

(52) U.S. Cl. CPC C08F 290/068

(57) ABSTRACT

A fluorine-free transparent polymeric material with high oxygen permeability includes at least one silicone cage compound having at least one polymerizable pendant group and up to seven side chains, at least one acrylic compound, at least one acrylate functionalized compound, and styryltris(trimethylsiloxy)silane. None of the compounds of the transparent polymeric material contain the element fluorine. A first polyhedral oligomeric silsesquioxane (POSS) monomer silicone cage has one polymerizable methacrylate pendant group and seven isoalkyl side chains while a second polyhedral oligomeric silsesquioxane (POSS) monomer silicone cage has two polymerizable methacrylate pendant groups and six isoalkyl side chains. The Dk of the transparent polymeric material is approximately 150 and the Shore D hardness is greater than 70.

### CROSS REFERENCE TO RELATED APPLICATIONS

The present application is a continuation of International Application No. PCT/US2024/034411, filed Jun. 17, 2024, which claims priority to U.S. Provisional Application No. 63/508,662, filed Jun. 16, 2023, all of which are hereby incorporated by reference herein in their entireties.

### TECHNICAL FIELD

The present invention relates to high gas permeable (Dk) materials that do not contain fluorine and methods of the same; and more particularly to high Dk materials having Dk values greater than 100; and still more particularly to high Dk materials suitable for use as rigid gas permeable contact lenses, including rigid gas permeable lenses.

### BACKGROUND OF THE INVENTION

Contact lens materials are transparent materials made from organic polymers that are highly crosslinked. Two types of lenses are available which are either soft or hard. Soft lenses are categorized as silicone hydrogels made from combining soft silicone polymers with hydrophilic polar materials. This combination of properties makes the silicone hydrogels the preferred lens for comfort on the patient's eye. Unfortunately, silicone hydrogel lenses have low oxygen permeability which can cause damage in the eye over a long period.

On the other hand, hard lenses are generally hydrophobic and may need surface modification to allow good wetting in the eye. Wetting in hard lenses, or rigid gas permeable (RGP) lenses, is achieved by adding acids that re-arrange to the surface of the lens. As the name implies, RGP lenses have increased oxygen permeability. This property that allows oxygen transport through the material is an important advantage for the health of the eye. Unfortunately, RGP lenses incorporate fluorinated acrylates which can cause damage to the environment and be dangerous to the contact lens wearer.

Incorporation of fluoroacrylates into the lens increases the mechanical properties by making the lens stiffer. At the same time, the oxygen permeability of these materials is higher than those that do not incorporate these monomers. One of the most useful monomers is hexafluoro-i-propylmethacrylate (HFiPMA).

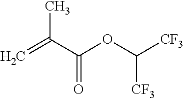

However fluorinated compounds have recently been targeted for removal from many products due to health issues. Many studies of PolyFluoroOctinoic Acid (PFOA) and Substances (PFOS) have found high levels of fluorinated materials in the blood of the general public. The acid (PFOA) is a common precursor used to prepare substances (PFOS) including acrylate monomers.

Recent attempts to remove fluorinated monomers from contact lenses have not been successful. To date, replacement of fluorinated compounds in RGP lenses have shown a large degradation in properties. By way of example, substitution of methyl methacrylate (MMA) for the HFiPMA caused an 87% decrease in oxygen permeability; substitution of 3-methacryloxypropyl tris(trimethylsiloxy)silane (TRIS) for HFiPMA produced materials that were difficult to lathe; and a 1/1 mixture of MMA and TRIS in place of HFiPMA reduced the oxygen permeability by about half, and significantly lowered the hardness, flexural modulus, and wettability of the resultant material.

Polyhedral Oligomeric Silsesquioxane (POSS) monomers have been incorporated into ophthalmic materials. In one example, U.S. Pat. No. 6,586,548 (the '548 patent) teaches the polymerization of vinyl monomer for biocompatible materials where one of the components is POSS monomer. The POSS monomer may have a single ethylenically unsaturated radical to serve as the polymerizable functional group. These materials can be transparent and suitable for contact lenses; however, the oxygen permeability of these materials is low, with Dk values of about 17-34.

In another example, U.S. Pat. No. 7,198,639 (the '639 patent) uses hydrosilation by reaction of silicon-hydrides with vinyl groups and a platinum catalyst to incorporate POSS cages into soft lenses. Alternatively, free radical polymerization is used to incorporate POSS cage acrylic and/or styrenic groups. POSS molecules functionalized with alcohol, amine, thiol, epoxy and isocyanate groups were also shown to be useful in the '639 patent. The POSS molecules are multifunctional, with three functional groups emanating from the vertices of open cages. These polymeric compositions can be made into intraocular lens (IOL) implants, corneal inlays, and other related objects. However, the oxygen transport properties of these materials were not reported, as these materials were intended for implantation into the eye.

In still another example, U.S. Pat. No. 10,633,472 (the '472 patent) describes a method for preparing materials with high oxygen transport (high Dk). The monomers include fluoroacrylates, a hydroxyalkyl tris(trimethylsiloxy)silane, a hydroxyalkyl terminated polydimethylsiloxane, and styrylethyltris(trimethlysiloxy)silane (styryl tris). A crosslinking agent, such as alkylglycol dimethacrylate, and a hydrophilic agent, such as methacrylic acid, were also included with Dk values greater than 175 reported. The materials were also able to be fashioned with a lathe into rigid gas permeable (RGP) contact lenses.

In a further example, POSS methacrylate was incorporated into a poly(urethane) as disclosed within publication number WO 2016/115507. The cured compositions of the polymeric compositions were suited for intraocular lenses and contact lenses while the urethane-based acrylate copolymers were also applicable to other corneal prosthetics.

In a final example, U.S. Patent Application 2022/0380599 describes a high Dk contact lens material that contains POSS cages with at least two polymerizable groups and at least two hydrophilic groups. It is noted, however, that fluoroacrylates are incorporated into these materials.

### SUMMARY OF THE INVENTION

In accordance with an aspect of the present invention, a new class of ophthalmic devices that are primarily silicone were formed into transparent materials that impart high oxygen permeability (Dk greater than I 00). These silicone materials were shaped into RGP lenses that display high Dk in the absence of fluorinated comonomers. The silicone monomers that replace the fluorinated monomers are Polyhedral Oligomeric Silsesquioxane (POSS) cages with at least one polymerizable group and a plurality of organofunctional groups. Further, POSS monomers with two available sites for polymerization allow for the incorporation of the silsesquioxane cage into the backbone of a macromolecule. In this way, the architecture of the resulting polymer is different for POSS monomers that have a single polymerizable group, where the resulting silicone cage is pendant to the polymer backbone.

Additionally, POSS monomers with more than two polymerizable groups form gel like structures. By incorporating the POSS cage into the polymer backbone, the structure of the resulting polymer can have linked silicone cages in a linear array or may incorporate other polymerizable monomers to form linear copolymers. POSS cages that are pendant to the polymer chain can result from polymerization of POSS molecules with one or more polymerizable groups.

Normally, it is necessary to combine fluorinated monomers with silicone to achieve high Dk materials with properties suitable for lens formation. However, combining the POSS silicones with organosilicons produces materials that are transparent with good mechanical properties. Organofunctional silicones may include acrylates, methacrylates, styrenics, and itaconates as the polymerizable group.

### BRIEF DESCRIPTION OF THE DRAWINGS

The present subject matter will now be described in detail with reference to the drawings, which are provided as illustrative examples of the subject matter so as to enable those skilled in the art to practice the subject matter. Notably, the figures and examples are not meant to limit the scope of the present subject matter to a single embodiment, but other embodiments are possible by way of interchange of some or all of the described or illustrated elements and, further, wherein:

FIG. 1 is a table showing exemplary compositions for forming non-fluorinated polymeric materials in accordance with the present invention, wherein a thermal initiator is used in the polymerization reaction;

FIG. 2 is a table showing characterization data of the exemplary non-fluorinated polymeric materials produced using the exemplary compositions listed in FIG. 1;

FIG. 3 is a plot showing reciprocal transmissibility versus thickness to calculate a Dk value for Comparative Example 1 as listed in FIG. 1;

FIG. 4 is a plot showing reciprocal transmissibility versus thickness to calculate a Dk value for Example 1 as listed in FIG. 1; and

FIG. 5 is a plot showing reciprocal transmissibility versus thickness to calculate a Dk value for Example 3 as listed in FIG. 1;

FIG. 6 is a table showing exemplary compositions for forming non-fluorinated polymeric materials in accordance with the present invention, wherein a photoinitiator is used in the polymerization reaction;

FIG. 7 is a table showing characterization data of the exemplary non-fluorinated polymeric materials produced using the exemplary compositions listed in FIG. 6; and

FIG. 8 is a plot showing tan (delta) versus weight percent composition of difunctional POSS to measure the glass transition temperature of the exemplary non-fluorinated polymeric materials produced using the exemplary compositions listed in FIG. 6.

### DETAILED DESCRIPTION

Rigid gas-permeable monoliths are cut into lens shapes to improve visual acuity in people with astigmatisms. Early lenses were made from poly(methyl methacrylate). Many generations of fluoroacrylates and siloxanes have led to improved oxygen permeability and wettability. This has resulted in both greater comfort to the patient and improved health within the eye.

As set forth below, one aspect of the present invention is directed to biocompatible materials that replace fluorinated components with siloxanes, such as POSS cages. POSS cages are relatively high molecular weight and have at least one, and often two or more, polymerizable groups attached to the silsesquioxane cage. The POSS cages may be more accurately described as macromers than monomers. As described in greater detail below, through the judicious choice of the POSS macromer, transparent materials with properties suitable for contact lenses with high oxygen permeability may be produced. Previous high Dk contact lens formulations included a high proportion of fluorinated segments, unlike the materials described herein.

The siloxanes used in contact lens synthesis are generally linear and branched siloxanes. Linear siloxanes include silicone polymers, such as polydimethylsiloxane, usually fit the molecular formula R2SiO, with two methyl groups bonded to the silicon atom and one bridging oxygen group for each silicon. They are often functionalized with a polymerizable group at one or both ends. The small molecule pentamethyldisiloxanyl methylmethacrylate (structure (I)) is a simple form of a linear siloxane.

TRIS groups are branched siloxanes, where a central silicon atom is

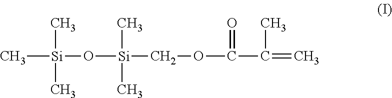

bonded to one organic group that can also contain a polymerizable group. The three groups bonded to the central silicon are composed of silicon-oxygen bonds to other silicon atoms. The central atom of the TRIS structure has the formula RSiO1.5. An early description of TRIS type molecules from U.S. Pat. No. 3,808,178 to Gaylord is structure (II), namely 3-[Tris(trimethylsiloxy)silyl]propyl methacrylate.

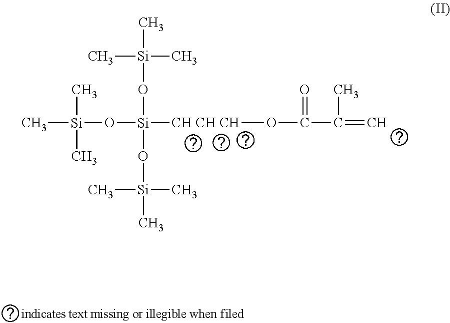

A third class of silicones useful in contact lenses is silicon-containing cage molecules, based upon the structure of oxygen and silicon tetrahedrons. The silicon atoms are substantially bonded to other silicon atoms through siloxane bonds, and one of the simplest structures formed from this arrangement is a cube, as shown generally in structure (III). These silsesquioxane molecules also fit the RSiO1.5 formula, but unlike the TRIS molecules, form 3 dimensional structures. These molecules take on the name POSS, which stands for Polyhedral Oligomeric Silsesquioxane. POSS molecules may have a silica type core and organic side groups that are covalently attached to the vertices of the inorganic polyhedron, and are commonly thought to bridge the gap between organic and inorganic materials. Through judicious choice of chemistry, one can obtain properties that represent the best of each component. Structure (III) is an idealized POSS cage with two polymerizable groups, with the remaining vertices comprising isobutyl co-substituents. POSS III is commercially available under product number HC0709.13 from Hybrid Plastics (Hattiesburg, Mississippi).

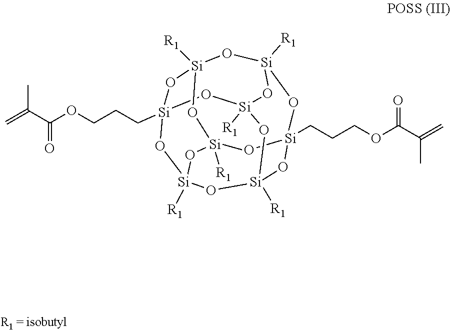

Highly functionalized POSS cages may be linked together through the acrylate side groups during polymerization. The cages are essentially pre-polymers or macromers due to the combination of their high molecular weight (generally greater than 1000 amu) and high functionality. The functionality is locked into place during the polymerization and extends throughout the material and phase separation is minimized. This leads to the isobutyl side groups extending throughout the polymer matrix.

The POSS cage is part of the polymer backbone with the polymer chains extending from each side of the cage. These POSS molecules can be classified as telechelic monomers, which polymerize with themselves or with other monomers to incorporate the POSS cage into the polymer backbone. These can then be thought of as telechelic oligomers. A telechelic monomer/oligomer/polymer is a di-end-functional polymer where both ends possess the same functionality. In this way the flexible polymerizable groups can be used to incorporate the cage-like silicone into the polymer backbone to create materials that are flexible and durable. In accordance with an aspect of the present invention, POSS cages with two polymerizable groups allow for the design of contact lens materials that can be either soft or hard, and at the same time display high oxygen transport.

Also useful are POSS cages with a single polymerizable group. By way of example, a POSS cage which incorporates a propyl methacrylate polymerizable group may be incorporated into the polymer network as a pendant POSS cage. The remaining side groups can be a large number of organic moieties. By way of example and without limitation thereto, isobutyl side groups form a crystalline product which is commercially available as a white powder from Hybrid Plastics (Hattiesburg, Mississippi) as product number MA0702. The crystallinity of the isobutyl product suggests that the molecule is a single cage structure as represented generally by the POSS structure IV. In a further example, incorporation of isooctyl side groups forms an amorphous POSS molecule having a general structure shown as POSS V which is commercially available as a clear liquid from Hybrid Plastics (Hattiesburg, Mississippi) as product number MA0719. In contrast to POSS IV, the isooctyl derivatized cage of POSS V may be a mixture of different size cages. That is, POSS V may be a mixture of silsesquioxane cages containing 8, 10, or 12 silicon atoms. It should also be noted that each of the POSS molecules may be a mixture of silsesquioxane cages with the functionality (e.g., the methacrylate side groups) being randomly distributed around the cages. To that end, the drawings do not represent exact structures, but are rather idealized structures.

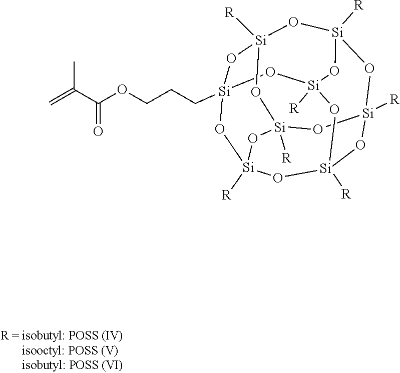

amorphous Unlike POSS (IV) which is a crystalline compound of an exact structure with a cage size of 8 silicon atoms, the amorphous POSS (VI) is a mixture of including cages of larger sizes, both opened and closed. POSS (VI) is more compatible with the other monomers of the formulation. It is more soluble in organic solvents than the crystalline POSS (IV).

In accordance with a further aspect of the present invention, a method of producing a high Dk material (Dk greater than 100) comprises contacting and reacting: one or more POSS methacrylates; an alkyl glycol dimethacrylate; a hydrophilic agent, such as methacrylic acid; a methacryl functional tris(trimethylsiloxy)silane; a methacryl functional terminated polydimethylsiloxane; and styryltris(trimethylsiloxy)silane. By way of example and without limitation thereto, the POSS may be a combination of structure (III) HC0709.13 and the isobutyl POSS of structure (IV) MA0702, the alkyl glycol dimethacrylate may be neopentyl glycol dimethacrylate; the methacryl functional tris(trimethylsiloxy)silane may be 3-methacryloyloxypropyl tris(trimethylsiloxy)silane; and the methacryl functional terminated 4-methacryloxybutyl terminated polydimethylsiloxane may be polydimethylsiloxane. Further exemplary compositions may also include the addition of 1,3-Bis(3-(methacryloxy)propyl)-1,1,3,3-tetrakis(trimethylsiloxy)disiloxane (Tris Dimer).

The reaction may be conducted within an inert atmosphere (e.g., under nitrogen, argon and/or helium) for a period of time and at a temperature sufficient to produce the high Dk material. The reaction may be conducted at room temperature, e.g., between about 20° C. and about 25° C. when a photoinitiator is present, or at an elevated temperature, such as up to about 100° C. when a thermal initiator is added to the formulation. As a result, the high Dk material may have a Dk value greater than 100. In a further aspect, the high Dk materials produced in accordance with the present invention do not require surface treatments, such as plasma treatments, if hydrophilic agents such as methacrylic acid are built into the polymer matrix. Additionally, as used herein, the terms “about” and “approximately” when associated with any value shall be interpreted as within plus-or-minus five percent (+/−5%) of the value stated.

### Advantages

Exemplary, non-limiting advantages of this invention may include:
a) fluorine is not present in the polymer matrix;
b) the material is composed primarily of siloxanes of several different forms;
c) the material is transparent;
d) the dry material is hard enough to be formed into ophthalmic lenses on a lathe;
e) the material can be polymerized in a mold and formed directly into a lens or button;
f) the level of crosslinking can be controlled by mixing POSS cages having a single polymerizable group with POSS cages having two or more polymerizable groups; and
g) less shrinkage occurs during polymerization due to the higher molecular weight of the POSS macromers.

### Examples

The following examples are for demonstration only and are not meant to limit the present disclosure solely thereto.

### I. Thermal Polymerization to Form Rods

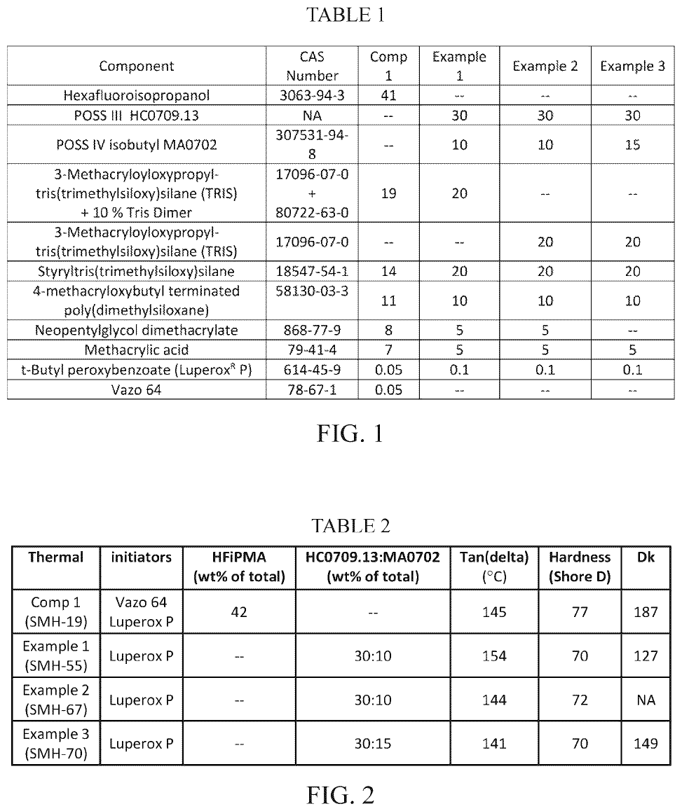

Non-fluorinated RGP samples that contain 40% POSS (which replaces HFIPMA) were prepared as described below. Polymeric rods containing the POSS were fashioned into discs or buttons in three cases. The buttons were transparent to light and had good mechanical properties that were suitable to lathe cutting into lenses. The compositions of the Examples are set forth in Table 1 shown in FIG. 1. Oxygen permeability was measured using a Dk Polarographic Cell and reported in Table 2 as shown in FIG. 2, along with, hardness, and appearance. It should also be noted that, alternatively, the buttons or lenses could be fashioned directly from a polypropylene mold using ultra violet or blue light.

Examples 1-3 as shown in Table 1 were made by thermal polymerization using a peroxide initiator, LUPEROX P. Each example 1-3 is comprised of 90 wt % or more siloxane monomers and no fluorine components. The polymerization was carried out under nitrogen at 55 and 95° C. Each temperature was held for 24 hours with 6 hour ramps to achieve each. The polymerized rods were removed from the tube casing and annealed at 120° C. for 24 hours. Extraction of residual monomer and oligomers was carried out by soaking in dichloromethane (DCM) overnight. The level of extraction was low and the shape of the button was not affected by the solvent. It should be noted that the relative weight percents of the composition components do not include any mass or associated weight percent added by the initiator(s).

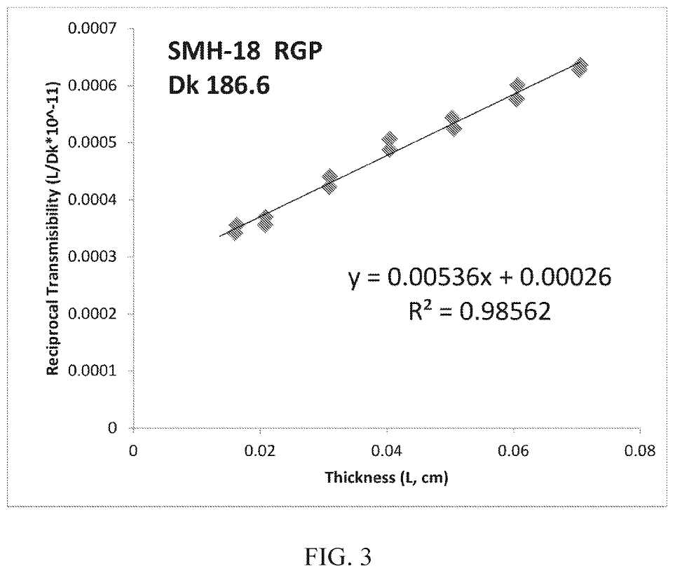

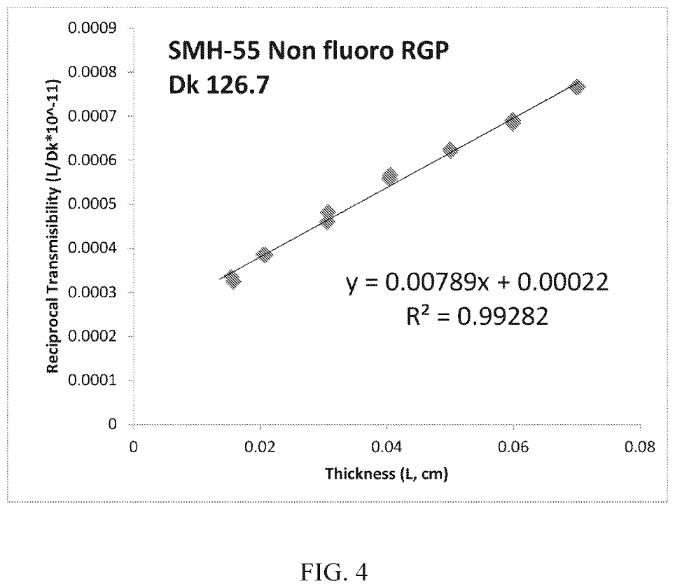

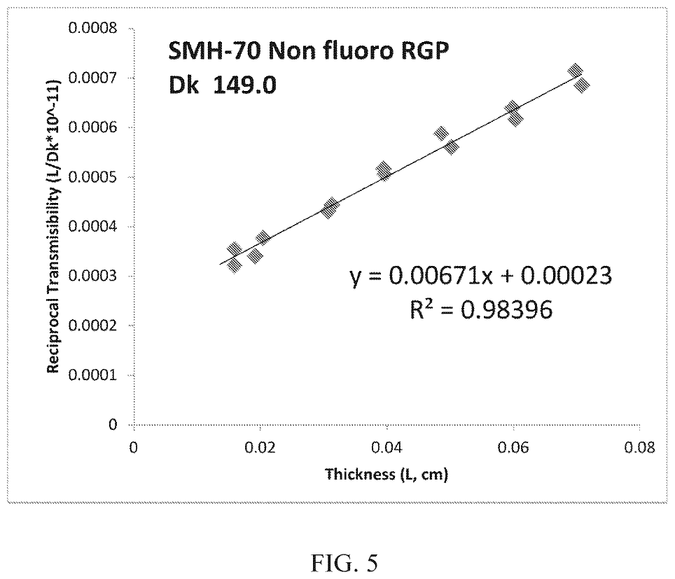

The tan delta peak, shown in FIG. 2 as Table 2, was obtained by dynamic mechanical analysis (DMA) and represents the glass transition temperature (Tg) of the buttons between 140-155° C. The Shore D hardness of Examples 1 and 2 was 70 and 72, respectively. The Dk for each example was determined from the reciprocal of the slope of the line in FIGS. 3-5, respectively. Note that Comparative Example 1 did not contain any POSS materials but was made instead with fluoroacrylate. As can be seen in FIG. 2, the properties of the Examples were similar to the Comparative Example, but notably did not contain fluoroacrylate or any other fluorinated materials.

### II. Photo-Polymerization to Form Buttons

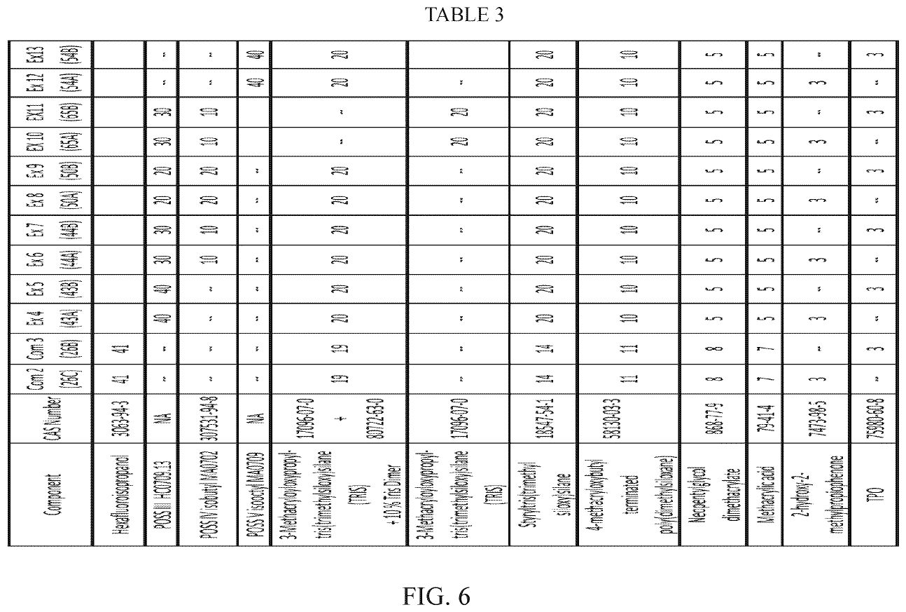

Polymeric buttons were fashioned by photopolymerization in a nitrogen chamber at room temperature. Polypropylene molds were used to produce buttons approximately 15 mm in diameter and 5 mm in thickness. Polymerization time was approximately 10 minutes using a Dymax 400W Flood Bulb Light Curing System with a peak at 370 nanometers. The compositions are compiled as Table 3 in FIG. 6. As can be seen un FIG. 6, none of Examples 4-13 contain fluorine. As with the thermal polymerizations above, the POSS cages provide an all-silicone network while at the same time providing good mechanical properties. Thus, the POSS macromers provide all the advantages of the fluoroacrylates without the introduction of the PFAS moieties. It should also be noted that Comparative Examples 2 and 3 employ the same fluorinated composition as in Comparative Example 1 (FIG. 1).

As shown in Table 3 of FIG. 6, Examples 4, 6, 8, and 10 have the same composition as 5, 7, 9, and 11, respectively, except the even number set used the UV initiator 2-hydroxy-2-methylpropiophenone while the odd number set used the blue light initiator diphenyl-(2,4,6-trimethyl benzoyl) phosphine oxide (TPO). The experiments used various combinations of POSS III and POSS IV (Table 3). It is noted Examples 4-11 POSS V was photopolymerized with HMPP in Example 12 and with TPO in Example 13.

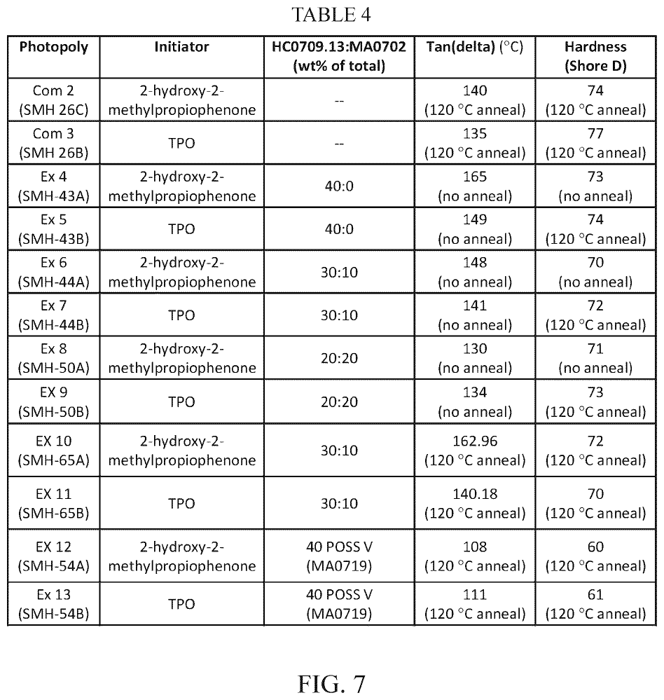

All the buttons were clear and showed little extractions after soaking in DCM overnight. The mechanical properties for Examples 4-13 are summarized in Table 4 of FIG. 7 and are consistent with properties useful to fashion into contact lenses. Example 12 and 13 showed that an amorphous POSS molecule with one polymerizable group (POSS V) can be polymerized into transparent polymeric material with mechanical properties consistent with gas permeable lenses. It is noted Examples 4-11 (POSS IV) also formed transparent materials with mechanical properties consistent with gas permeable lenses.

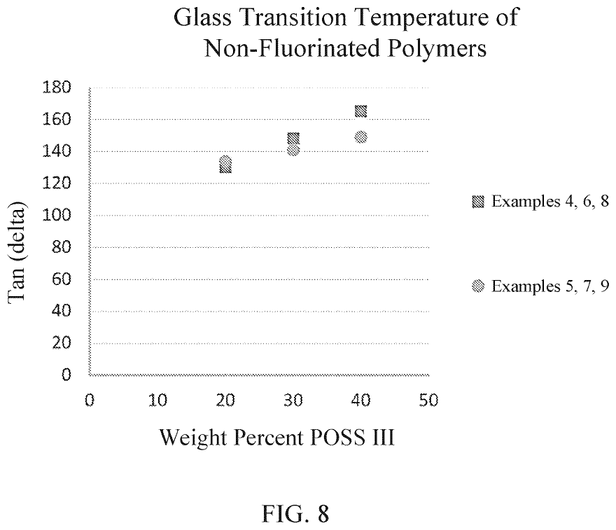

The maximum of the tan (delta) peak is a measurement of the glass transition temperature by DMA, as plotted in FIG. 8, with Examples 4, 6, and 8 represented by the squares and Examples 5, 7, and 9 represented by the circles. As can be seen in FIG. 8, the Tg is higher when the amount of cross-linker is increased as reflected in the level of increased level of difunctional POSS III (HC0709.13) leading to higher Tg.

As can be seen by the above description in view of the drawings, the properties of materials made with POSS compounds are similar to the properties of the materials made with fluorinated monomers. Thus, in contrast to the current state of the art, contact lens materials may be manufactured without the use of fluorine.

The detailed description set forth herein in connection with the appended drawings is intended as a description of exemplary embodiments in which the presently disclosed subject matter may be practiced. The term “exemplary” used throughout this description means “serving as an example, instance, or illustration,” and should not necessarily be construed as preferred or advantageous over other embodiments.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded the widest scope consistent with the principles and novel features disclosed herein. It is contemplated that additional embodiments are within the spirit and true scope of the disclosed subject matter.

What is claimed is:

1. A fluorine-free transparent polymeric material with high oxygen permeability comprising:
a) at least one silicone cage compound having at least one polymerizable pendant group and up to seven side chains;
b) at least one acrylic compound;
c) at least one acrylate functionalized compound; and
d) styryltris(trimethylsiloxy)silane,
wherein all of compounds comprising the transparent polymeric material do not contain the element fluorine; and
the at least one silicone cage is a first polyhedral oligomeric silsesquioxane (POSS) monomer having one polymerizable methacrylate pendant group and seven isoalkyl side chains.

2. The fluorine-free transparent polymeric material in accordance with claim 1, further comprising a Dk of approximately 150 and a Shore D hardness greater than 70.

3. The fluorine-free transparent polymeric material in accordance with claim 1, further comprising a Dk of approximately 125 and a Shore D hardness greater than 70.

4. The fluorine-free transparent polymeric material in accordance with claim 1, wherein the at least one silicone cage comprises at least 40% weight of the polymeric material.

5. The fluorine-free transparent polymeric material in accordance with claim 1, wherein the at least one silicone cage is a second POSS monomer having two polymerizable methacrylate pendant groups and six isoalkyl side chains.

6. The fluorine-free transparent polymeric material in accordance with claim 5, wherein the isoalkyl side chains of the first POSS monomer and the second POSS monomer are isobutyl side chains, isooctyl side chains, or both.

7. The fluorine-free transparent polymeric material in accordance with claim 5, wherein the isoalkyl side chains of the first POSS monomer and the second POSS monomer are all isobutyl side chains.

8. The fluorine-free transparent polymeric material in accordance with claim 1, further comprising at least one disiloxane compound.

9. The fluorine-free transparent polymeric material in accordance with claim 8, wherein the at least one disiloxane compound is 1,3-Bis(3-(methacryloxy)propyl)-1,1,3,3-tetrakis(trimethylsiloxy)disiloxane.

10. The fluorine-free transparent polymeric material in accordance with claim 1, wherein the at least one acrylic compound is methacrylic acid.

11. The fluorine-free transparent polymeric material in accordance with claim 1, wherein the at least one acrylate functionalized compound is one or more of an alkyl glycol dimethacrylate, a methacryl functional tris(trimethylsiloxy)silane, and a methacryl functional terminated polydimethylsiloxane.

12. The fluorine-free transparent polymeric material in accordance with claim 11, wherein the alkyl glycol dimethacrylate is neopentyl glycol dimethacrylate.

13. The fluorine-free transparent polymeric material in accordance with claim 11, wherein the methacryl functional tris(trimethylsiloxy)silane is 3-methacryloxypropyl tris(trimethylsiloxy)silane.

14. The fluorine-free transparent polymeric material in accordance with claim 11, wherein the methacryl functional terminated polydimethylsiloxane is 4-methacryloxybutyl terminated polydimethylsiloxane.

15. The fluorine-free transparent polymeric material in accordance with claim 11, wherein the at least one silicone cage, the styryltris(trimethylsiloxy)silane, the methacryl functional tris(trimethylsiloxy)silane, and the methacryl functional terminated polydimethylsiloxane comprise at least 90% of the transparent polymeric material.

16. The fluorine-free transparent polymeric material in accordance with claim 1, further including a thermal polymerization initiator.

17. The fluorine-free transparent polymeric material in accordance with claim 1, further including a UV polymerization initiator.

18. The fluorine-free transparent polymeric material in accordance with claim 1, further including a blue-light polymerization initiator.
